(19) United States
(12) Patent Application Publication
(10) Pub. No.: US 2009/0112865 A1
(43) Pub. Date: Apr. 30, 2009

(54) HIERARCHICAL STRUCTURE ENTROPY MEASUREMENT METHODS AND SYSTEMS

(76) Inventors: Erik N. Vee, San Jose, CA (US); Deepayan Chakrabarti, Mountain View, CA (US); Anirban Dasgupta, Santa Clara, CA (US); Arpita Ghosh, Santa Clara, CA (US); Shanmugasundaram Ravikumar, Berkeley, CA (US); Andrew Tomkins, San Jose, CA (US)

Correspondence Address: BERKELEY LAW & TECHNOLOGY GROUP LLP, 17933 NW EVERGREEN PARKWAY, SUITE 250, BEAVERTON, OR, 97006, US

(21) Appl. No.: 11/925,355

(22) Filed: Oct. 26, 2007

(51) Int. Cl. G06F 7/00

(52) U.S. Cl. 707/7; 707/E17.084

(57) ABSTRACT

Methods and apparatuses are provided for accessing taxonomic data associated with an item as classified into a taxonomy having a hierarchical structure, establishing dependency data associated with a distribution represented in the taxonomic data, and determining entropic data for the item based, at least in part, on the distribution and established dependency.

### BACKGROUND

1. Field

The subject matter disclosed herein relates to data processing, and more particularly to data processing methods and systems that measure entropy and/or otherwise utilize entropy measurements.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided which allow for the copious amounts of information to be searched through in an efficient manner. For example, service providers may allow for users to search the World Wide Web or other like networks using search engines. Similar tools or services may allow for one or more databases or other like data repositories to be searched.

With so much information being available, there is a continuing need for methods and systems that allow for pertinent information to be located or otherwise identified in an efficient manner.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is block diagram illustrating an exemplary embodiment of a computing environment system having one or more devices configurable to measure entropy or otherwise utilize entropy measurements.

FIG. 2 is a functional block diagram illustrating certain features in an exemplary entropy measurement process that may be implemented, for example, using one or more devices such as shown in FIG. 1.

FIG. 3 is a functional block diagram illustrating certain features in an exemplary entropy measurement process that may be implemented, for example, using one or more devices such as shown in FIG. 1.

FIG. 4 is a functional block diagram illustrating certain features in an exemplary divergence measurement process that may be implemented, for example, using one or more devices such as shown in FIG. 1.

FIG. 5 is a flow diagram illustrating an exemplary tree entropy measurement method and an exemplary tree divergence measurement method that may be implemented, for example, using one or more devices such as shown in FIG. 1.

FIG. 6 is an illustrative diagram showing items as classified into a taxonomy having a hierarchical structure that may be used, for example, by one or more devices such as shown in FIG. 1.

### DETAILED DESCRIPTION

Techniques are provided herein that may be used to allow for pertinent information to be located or otherwise identified in an efficient manner. These techniques may, for example, allow for more efficient searching of items that may be classified into a taxonomy having a hierarchical structure by measuring entropy associated with the classification distribution and inherent hierarchical dependency.

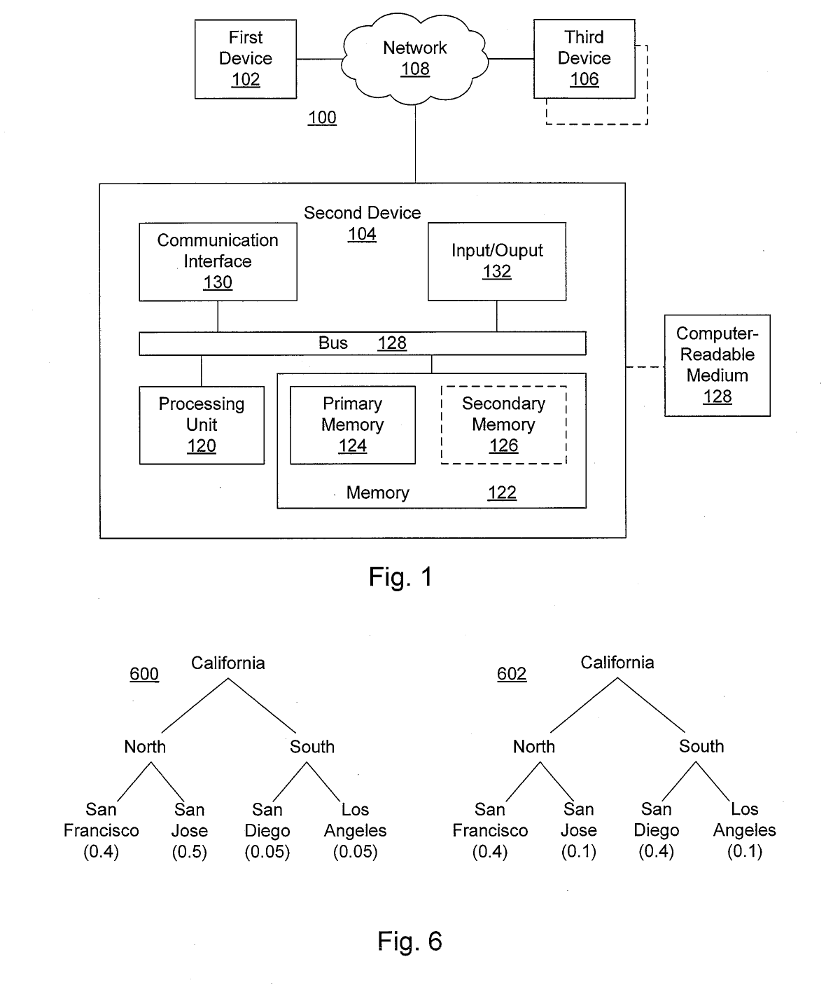

FIG. 1 is block diagram illustrating an exemplary embodiment of a computing environment system 100 that may include one or more devices configurable to measure entropy and/or divergence, or to otherwise utilize entropy measurements. System 100 may include, for example, a first device 102, a second device 104 and a third device 106, which may be operatively coupled together through a network 108.

First device 102, second device 104 and third device 106, as shown in FIG. 1, are each representative of any device, appliance or machine that may be configurable to exchange data over network 108. By way of example but not limitation, any of first device 102, second device 104, or third device 106 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 108, as shown in FIG. 1, is representative of one or more communication links, processes, and/or resources configurable to support the exchange of data between at least two of first device 102, second device 104, and third device 106. By way of example but not limitation, network 108 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated, for example, by the dashed lined box illustrated as being partially obscured of third device 106, there may be additional like devices operatively coupled to network 108.

It is recognized that all or part of the various devices and networks shown in system 100, and the processes and methods as further described herein, may be implemented using or otherwise include hardware, firmware, software, or any combination thereof.

Thus, by way of example but not limitation, second device 104 may include at least one processing unit 120 that is operatively coupled to a memory 122 through a bus 128.

Processing unit 120 is representative of one or more circuits configurable to perform at least a portion of a data computing procedure or process. By way of example but not limitation, processing unit 120 may include one or more processors, controllers, microprocessors, microcontrollers, application specific integrated circuits, digital signal processors, programmable logic devices, field programmable gate arrays, and the like, or any combination thereof.

Memory 122 is representative of any data storage mechanism. Memory 122 may include, for example, a primary memory 124 and/or a secondary memory 126. Primary memory 124 may include, for example, a random access memory, read only memory, etc. While illustrated in this example as being separate from processing unit 120, it should be understood that all or part of primary memory 124 may be provided within or otherwise co-located/coupled with processing unit 120.

Secondary memory 126 may include, for example, the same or similar type of memory as primary memory and/or one or more data storage devices or systems, such as, for example, a disk drive, an optical disc drive, a tape drive, a solid state memory drive, etc. In certain implementations, secondary memory 126 may be operatively receptive of, or otherwise configurable to couple to, a computer-readable medium 128. Computer-readable medium 128 may include, for example, any medium that can carry and/or make accessible data, code and/or instructions for one or more of the devices in system 100.

Second device 104 may include, for example, a communication interface 130 that provides for or otherwise supports the operative coupling of second device 104 to at least network 108. By way of example but not limitation, communication interface 130 may include a network interface device or card, a modem, a router, a switch, a transceiver, and the like.

Second device 104 may include, for example, an input/output 132. Input/output 132 is representative of one or more devices or features that may be configurable to accept or otherwise introduce human and/or machine inputs, and/or one or more devices or features that may be configurable to deliver or otherwise provide for human and/or machine outputs. By way of example but not limitation, input/output device 132 may include an operatively configured display, speaker, keyboard, mouse, trackball, touch screen, data port, etc.

With regard to system 100, in certain implementations first device 102 may be configurable, for example, using a browser or other like application, to seek the assistance of second device 104 by providing or otherwise identifying a query that second device 104 may then process. For example, one such query may be associated with a search engine provider service provided by or otherwise associated with second device 104. In response to such a query, for example, second device 104 may then provide or otherwise identify a query response that first device may then process.

Here, for example, to process such a query second device may be configured to access stored data associated with various items that may be available within system 100 and which may be of interest or otherwise associated with information included within the query. The stored data may, for example, include data that identifies the item, its location, etc. By way of example but not limitation, the item may include a document or web page that is accessible from, or otherwise made available by, third device 106 as part of the World Wide Web portion of the Internet.

Continuing with this example, second device 104 may be configured to examine the stored data in such a manner as to identify one or more items deemed to be relevant to the query. By way of example but not limitation, second device 104 may be configurable to select items deemed relevant to such a query based, at least in part, on scores assigned to or otherwise associated with potential candidate items. Such scores (e.g., PageRank, etc.) and/or other like useful search engine data may, for example, result from other processes conducted by second device 104 or other devices. For example, one or more devices may be configurable to identify items, classify. items, and/or score the items as needed to provide or maintain additional (e.g., perhaps local) stored data that may be accessed by a search engine in response to a query.

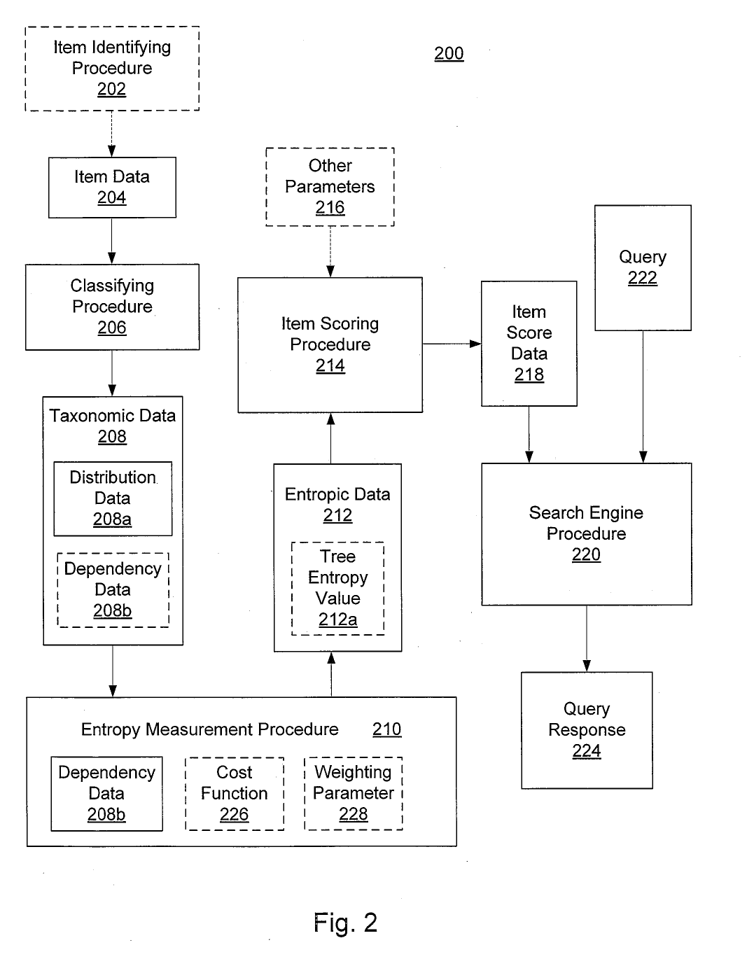

Reference is now made to FIG. 2, which is a functional block diagram illustrating certain features in an exemplary entropy measurement process 200 that may be implemented, for example, using one or more devices such as those in system 100.

Process 200 may, for example, include at least one item identifying procedure 202 that generates or otherwise identifies item data 204. By way of example but not limitation, item identifying procedure 202 may include one or more web crawlers or other like processes that communicate with applicable devices coupled to network 108 and operate to gather information about items available through or otherwise made accessible over network 108 by such devices. Such processes and other like processes are well known and beyond the scope of the present subject matter.

Item data 204 may, for example, include information about the item such as identifying information, location information, etc. Item data 204 may, for example, include all or a portion of the text or words associated with information that may be included in the item.

As used herein, the term “item” is meant to include any form or type of data that may be communicated. By way of example but not limitation, an item may include all or part of one or more web pages, documents, files, databases, objects, messages, queries, and the like, or any combination thereof.

Process 200 may, for example, include at least one classifying procedure 206 that accesses item data 204 and generates or otherwise identifies taxonomic data 208 associated with the item. By way of example but not limitation, classifying procedure 206 may be configurable to classify all or part of item data 204 into a taxonomy having a hierarchical structure. For example, at least a portion of one exemplary taxonomy may include a tree or sub-tree structure having a root node that is superior to one or more levels comprising one more inner nodes that are superior to a plurality of leaf nodes. Classifying procedure 206 may, for example, be configurable to assign distribution data 208a to such leaf nodes. For example, in certain implementations distribution data 208a may include a distribution value (e.g., a normalized value) or the like that is assigned to a leaf node. In other implementations, for example, distribution data 208a may include a probability associated with individual leaf nodes.

Taxonomic data 208 may, for example, include dependency data 208b that is associated with the hierarchical structure. For example, dependency data 208b may include data associated with the distribution and/or arrangement of inner nodes within the hierarchical structure.

An entropy measurement procedure 210 may be configurable to access taxonomic data 208 and generate or otherwise identify entropic data 212 associated with the taxonomic data and hence the item data. As illustrated in FIG. 2, entropic data 212 may, for example, include a tree entropy value 212a. The notion of “tree entropy” may, for example, be defined as shown in the examples presented in subsequent sections. Such definitions are applicable or otherwise clearly adaptable for use in entropy measurement procedure 210 and in generating or otherwise identifying entropic data 212 including tree entropy value 212a.

Entropy measurement procedure 210 may be configurable to access distribution data 208a and to either access and/or otherwise establish dependency data 208b (e.g., as shown within entropy measurement procedure 210). Dependency data 208b may, for example, be established based, at least in part, on the hierarchical structure, or an applicable portion thereof, as per the taxonomy applied by classifying procedure 206 and with consideration of the distribution data 208a.

As illustrated, entropy measurement procedure 210 may, for example, include the application of at least one cost function 226 in establishing dependency data 208b. As illustrated, entropy measurement procedure 210 may, for example, include the application of at least one weighting parameter 228 in establishing dependency data 208b. Several exemplary weighting parameters and cost functions, e.g., which may be used to establish weighting parameters, are described in greater detail below.

Also, as described in greater detail below, a tree entropy operation or formula may, by way of example but not limitation, be applied by entropy measurement procedure 210 such that the resulting entropic data 212 provides a measure of the extent to which the item is topic-focused with regard to the topic of the taxonomy.

In certain implementations, all or portions of dependency data 208b may be provided in taxonomic data 208, for example, as generated by classifying procedure 206 or the like. For example, it may be beneficial for classifying procedure 206 to be further configurable to perform at least some of the processing associated with the establishment of dependency data 208b (e.g., while establishing distribution data 208a). In other implementations, for example, all or portions of dependency data 208b may be established by measurement procedure 210.

With respect to exemplary process 200, entropic data 212 which may include, for example, tree entropy value 212a, which may then be provided or otherwise made accessible to an item scoring procedure 214. Item scoring procedure 214 may, for example, be configurable to establish or otherwise identify item score data 218. Item scoring procedure 214 may, for example, be configurable to establish item score data 218 based, at least in part, on entropic data 212 and one or more other parameters 216 (e.g., a PageRank or related metric(s), etc.). In certain implementations, for example, item score data 218 may include a single numerical score associated with the item identified in item data 204.

A search engine procedure 220 may be configurable to receive or otherwise access item score data 218 and based, at least in part, on item score data 218 provide or otherwise identify a query response 224 in response to a query 222.

Thus, as illustrated in the preceding example, in accordance with certain aspects of the methods and systems presented herein, entropy measurement techniques or resulting entropic measurements may be used to possibly refine or otherwise further support in some manner a data query, search engine, or other like data processing service, system, and/or device.

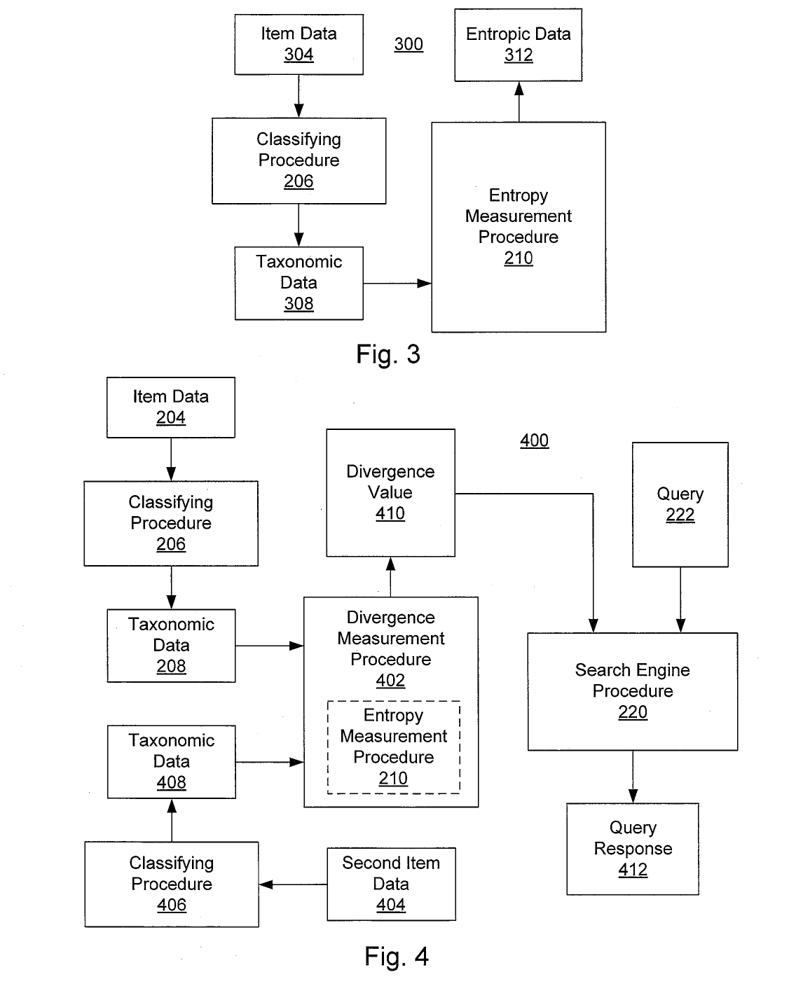

Reference is now made to FIG. 3, which is a functional block diagram illustrating certain features in an exemplary entropy measurement process 300 that may be implemented, for example, using one or more devices such as shown in FIG. 1. As illustrated, process 300 may, for example, include classifying procedure 206 that accesses item data 304 and establishes taxonomic data 308, and tree entropy procedure 210 that accesses taxonomic data 308 and establishes entropic data 312.

With this example, it is illustrated that entropy measurement techniques or resulting entropic measurements may be used to possibly test or otherwise study the performance of classifying procedure 206. Thus, for example, item data 304 may be carefully selected or otherwise specifically created to “focus” within a given taxonomy in a desired manner. For example, item data 304 may be thought to be very focusable or conversely barely focusable on the taxonomy. As such, once classifying procedure 206 has generated taxonomic data 308, tree entropy procedure 210 may be employed to generate entropic data 312, which may then be examined to judge the performance of classifying procedure 206.

Attention is now drawn to FIG. 4, which is a functional block diagram illustrating certain features in an exemplary tree divergence process 400 that may be implemented, for example, using one or more devices such as shown in FIG. 1. Process 400 may, for example, be yet another exemplary implementation based, at least in part, on the tree entropy techniques and methods presented herein. Process 400 may, for example, be used to determine or otherwise measure divergence between taxonomic data associated with two different items.

As shown process 400 may, for example, include classifying procedure 206 that accesses item data 204 and establishes taxonomic data 208, and a classifying procedure 406 that accesses second item data 404 and establishes taxonomic data 408. Here, for example, the classifying procedures 206 and 406 may be the same or different. Process 400 may include, for example, a divergence measurement procedure 402 (which may include an entropy measurement procedure 210) that accesses taxonomic data 208 and taxonomic data 408 to establish a divergence value 410. Process 400 may include, for example, a search engine procedure 220 that accesses at least the divergence value 410 in generating a query response 412 in response to query 222.

In process 400, divergence measurement procedure 402 may, for example, be configurable to measure similarity between the item associated with item data 204 and the second item associated with second item data 404. This measurement may be provided in divergence value 410, and may be used by search engine procedure 220 to adjust or otherwise affect query response 412. For example, in certain implementations, second item data may include or otherwise be based, at least in part, on query 222 such that the resulting tree divergence value 410 may represent how similar the item associated with item data 204 is to the query. In certain situations, it may be desirable for query response 412 to identify some items that do not appear to match as closely as other items that are identified. Thus, for example, if query 222 includes the term “mouse”, then it may be beneficial for the query response to identify some items that appear to focus on an “animal” mouse and others that appear to focus on “computer hardware” related mouse devices.

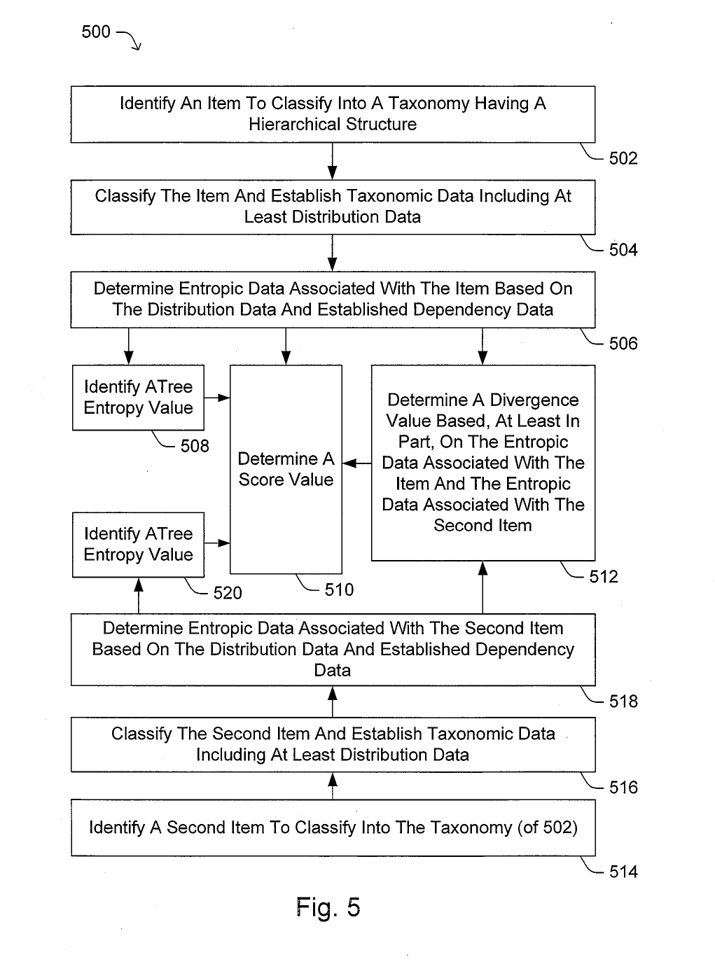

At this point attention is drawn to FIG. 5, which is a flow diagram illustrating an exemplary method 500 showing a tree entropy measurement method and a tree divergence measurement method, of which all or portions may be implemented, for example, using one or more devices such as shown in FIG. 1.

In 502, an item may be identified for classification into a taxonomy having a hierarchical structure. In 504, the item may be classified and taxonomic data including at least distribution data established. In 506, entropic data for the item may be determined based, at least in part, on the distribution data and established dependency data (e.g., associated with the distribution and hierarchical structure). In 508, a tree entropy value may be identified. In 510, a score value may be determined, for example, based, at least in part, on the tree entropy value from 508 and/or entropic data 506.

In 514, a second item may be identified for classification into the same taxonomy having the same hierarchical structure. In 516, the second item may be classified and taxonomic data including distribution data established. In 518, entropic data for the second item may be determined based, at least in part, on the distribution data and established dependency data. In 520, a tree entropy value may be identified. In 510, a score value may be determined, for example, based, at least in part, on the tree entropy value from 520 and/or entropic data from 518.

In 512, a divergence value may be determined based, at least in part, on the entropic data from 506 and 518. In 510, a score value may be determined, for example, based, at least in part, on the divergence value from 512.

In the following sections, certain exemplary techniques are described that may be used to measure or otherwise determine and/or utilize the entropy of a distribution that takes into account the hierarchical structure of a taxonomy. For example, a formal treatment of “tree entropy” is provided that may be used or otherwise adapted for use in system 100 or portions thereof.

As previously illustrated, one exemplary application of tree entropy may be in the classification of information, such as, where an item may be distributed over various leaf nodes of a given topic taxonomy and it may be desirable to measure or otherwise determine an extent to which the item is topic-focused.

As used herein, entropy refers to a fundamental measure of the uncertainty represented by a probability distribution. By way of example, given a discrete distribution p̅ on symbols [n] specified in the form of a vector p̅=p₁, . . . , pₙ with pᵢ≧0 and

$${\sum }_{i} {p}_{i} = 1 ,$$

the Shannon entropy H( p̅) is given by

$${\sum }_{i = 1}^{n} {p}_{i} lg ( 1 / {p}_{i} ) .$$

Assuming that a given item has membership in each of n classes (e.g., as assigned by a classifying procedure), in accordance with certain aspects of the methods and systems presented herein, it may be useful to determine to what extent the item is “focused” with respect to the classes. Here, by way of example but not limitation, such an item may be considered “focused” if its membership is “scattered” as little as possible among all the classes.

One approach might be to interpret the membership of the document in each of the n classes as a probability distribution, and use the Shannon entropy of this distribution as a measure of its focus.

However, considering a scenario where the n classes have some relationship among them; for instance, the classes might represent the leaf nodes of a tree (or sub-tree) that correspond to a geographical taxonomy.

FIG. 6, for example, illustrates the membership of two items 600 and 602 in each of four classes, where each class corresponds to a geographical location. As illustrated, items 600 and 602, this exemplary taxonomy includes a root node (labeled “California”) that is superior (e.g., a parent) to two inner nodes (labeled “North” and “South”), wherein the North inner node is superior to two leaf nodes (labeled “San Francisco” and “San Jose”) and the South inner node is superior to two leaf nodes (labeled “San Diego” and “Los Angeles”). In this example, item 600 has a distribution across the leaf nodes, with the distribution data of (0.4) for the San Francisco leaf node, (0.5) for the San Jose leaf node, (0.05) for the San Diego leaf node, and (0.05) for the Los Angeles leaf node. Item 602 has a different distribution across the leaf nodes, with the distribution data of (0.4) for the San Francisco leaf node, (0.1) for the San Jose leaf node, (0.4) for the San Diego leaf node, and (0.1) for the Los Angeles leaf node.

In this example, item 600 on the left in FIG. 6 appears more focused than item 602 on the right, however, according to the Shannon entropy, item 600 is exactly as (un)focused as item 602. This arises precisely since Shannon entropy ignores the semantics of the symbols associated with the distribution by assuming they are unrelated to each other. Thus, for example, the Shannon entropy of a distribution may not capture underlying relationships between symbols, such as those given by a taxonomy.

Thus, in accordance with certain aspects of the present subject matter, a more principled and/or systematic technique has been developed that may provide for methods and systems that consider entropic properties of a distribution on a hierarchical structure, such as, for example, dependency data associated with the hierarchal structure of a tree, sub-tree, or the like.

In the following sections an exemplary definition of “tree entropy” is provided by first postulating a set of axioms for tree entropy; these are generalizations of Shannon's axioms to a tree case. The set of axioms leads to a recursive definition from which an explicit functional form of tree entropy may be derived which satisfies the desired axioms. Several interesting properties of tree entropy will be described which tend to demonstrate the robustness of the definition. For example, tree entropy may be invariant under simple transformations of the tree and scaling of the probability distribution. Under an additional yet reasonable assumption on a cost function, for example, tree entropy may be a concave function. Further, under certain conditions tree entropy may be maximized for distributions corresponding to “maximum uncertainty” for the given tree structure. Still further, as will be described, a generalization of KL-divergence may be derived for tree entropy, for example, in the situation wherein two probability distributions over the same tree have the same cost function. Additionally, as shown below, an interpretation of tree entropy may be made, for example, by means of a model for generating symbols (e.g., in the form of or otherwise associated with dependency data).

Specifying natural requirements via a set of axioms and pinning down the functions satisfying these axioms has often resulted in fundamental insights for many problems, some well known ones being the axioms for voting (see, e.g., K. Arrow. Social Choice and Individual Values (2nd Ed.). Yale University Press, 1963), clustering (see, e.g., J. Kleinberg. An impossibility theorem for clustering. In Proceedings of the 16th Conference on Neural Information Processing Systems, 2002), and PageRank (see, e.g., A. Altman and M. Tennennholtz. Ranking systems: The pagerank axioms. In Proceedings of the 6th ACM Conference on Electronic Commerce, pages 1-8, 2005).

While these so-called axiomatic approaches have often been used to refute the existence of an ideal procedure in these problems, as shown below, the result for tree entropy appears to be different in that, after formulating certain rules, one may construct a function that uniquely satisfies them.

In accordance with certain embodiments, tree entropy may, for example, be adapted to measure a cohesiveness of an item when it is classified into a taxonomy. Thus, for example, tree entropy may be used to determine how focused or unfocused such an item is on a topic. One example of such an implementation is shown in FIG. 2.

In accordance with certain other embodiments, tree entropy may, for example, be adapted for use in measuring the performance of a classifying procedure. Thus, for example, given an item that is considered to be well focused one may use tree entropy to measure how well the classifying procedure performs in terms of placing such an item at the leaf nodes of a taxonomy hierarchy. One example of such an implementation is shown in FIG. 3.

In accordance with still other embodiments, as a consequence of a generalization of KL-divergence to trees, tree entropy may, for example, be adapted to measure similarity between a first item and a second item (e.g., a document and a query, respectively), wherein both the items are classified into the same taxonomy by one or more classifying procedures. This may be useful, for example, with search and retrieval services, or the like. One example of such an implementation is shown in FIG. 4.

An exemplary definition of tree entropy will now be developed in more specificity.

A rooted tree may be denoted by T, and its nodes by V(T). For each node ν of T, let π(ν) and C(ν) denote the parent nodes and the set of children nodes of v respectively. Nodes with empty C(ν) are the leaf nodes of T, denoted by l(T). Each tree T with n leaf nodes may have a set of probabilities p₁, . . . , pₙ associated with the corresponding leaf nodes, which may be denoted by the vector p̅. For a general node ν in T, one may recursively define pᵥ to be the sum of probabilities associated with the children of v, e.g.,

$${p}_{v} = {\sum }_{w ∈ C ( v )} {p}_{w} .$$

For simplicity one may use p_{T} to denote the probability associated with the root of the tree T.

Associated with each node νεV(T) is a non-negative real cost c_{T}(ν). For simplicity of notation, c(T) is used to denote the cost of the root of tree T. If T′ is a sub-tree of T, the cost function for T′ will be the natural restriction of that for T, e.g., c_{T′}(ν)=c_{T}(ν) for all nodes νεV(T′). One may drop the subscript and denote the cost function simply as c(·).

The tree entropy for tree T and probability vector \vec{p} may be denoted by H(T, p̅). For all sub-trees T′ of T, one may naturally define H(T′, p̅) by ignoring components of p̅ that are not needed. To normalize the entries (e.g., such that the relevant entries sum to one), one may define, for tree T with root r,

$$H ( T , \overline{p} ) = H ( T , \frac{1}{{p}_{r}} \overline{p} ) .$$

One may denote the Shannon entropy (or simply entropy) of a distribution by H₁( p̅). As with tree entropy, if

$${p}_{0} = {\sum }_{i \geq 1} {p}_{i} < 1 ,$$

then one may define

$${H}_{1} ( \overline{p} ) = {H}_{1} ( \frac{1}{{p}_{0}} \overline{p} ) .$$

For simplicity, the recursive definition of tree entropy will be presented first. After that, it will be shown how the definition actually arises from a set of axioms similar to the original entropy axioms by Shannon.

The recursive definition of tree entropy may include the base case R1, and the recursive hypothesis R2 that utilizes the structure of the tree.

R1. Base case (e.g., a “flat′ tree): For all n-dimensional p̅ with non-negative entries and

$${\sum }_{i ∈ [ n ]} {p}_{i} = {p}_{0} ,$$

$$H ( {S}_{n} , \overline{p} ) = c ( {S}_{n} ) {H}_{1} ( \overline{p} ) {=}^{Δ} - c ( {S}_{n} ) \frac{1}{{p}_{0}} {\sum }_{i ∈ [ p ]} {p}_{i} lg \frac{{p}_{i}}{{p}_{0}} ,$$

where H₁( p̅) is the Shannon entropy of the distribution p̅. Note that this implies that H(S₀, p̅)=0.

R2. Inductive case (e.g., with inner nodes in terms of children): Let the root of T have children u₁, . . . , uₖ, and let Tᵢ denote the sub-tree rooted at uᵢ, for each iε[k]. Let Sₖ be a star graph, whose root is the root of T and whose leaf nodes are u₁, . . . , uₖ. Further, let c(Sₖ)=c(T). Then for all p̅,

$$H ( T , \overline{p} ) = H ( {S}_{k} , \overline{q} ) + \frac{1}{{p}_{T}} {\sum }_{i ∈ [ k ]} {p}_{{u}_{i}} H ( {T}_{i} , \overline{p} ) ,$$

where q̅=(pᵤ_{₁}, . . . , pᵤ_{ₖ}).

Notice that R1 and R2 together provide the recurrence:

$$H ( T , \overline{p} ) = - c ( T ) {\sum }_{i ∈ [ k ]} \frac{{p}_{{u}_{i}}}{{p}_{T}} lg ( \frac{{p}_{{u}_{i}}}{{p}_{T}} ) + {\sum }_{i ∈ [ k ]} \frac{{p}_{{u}_{i}}}{{p}_{T}} H ( {T}_{i} , \overline{p} ) \qquad ( 1 )$$

Note that R1 essentially implies that for a tree (or sub-tree) with a single node, the tree entropy for that tree (or its restriction to a sub-tree) is trivially zero, irrespective of the probability of the node and its cost. For a “flat” tree (or sub-tree) of a root connected only to leaf nodes, the tree provides no additional information separating any set of leaf nodes from the rest, implying that each leaf is completely separate from the others. In this case, as R1 points out, the tree entropy reduces to Shannon entropy, (e.g., to within the constant factor c(Sₙ) ). R2 may be used, for example, to compute tree entropy by recursively using the base case: e.g., the tree entropy for a tree (or sub-tree) is the sum of those of its children sub-trees, plus the additional entropy incurred in the distribution of the probability at the root among its children. The costs at each node may be used in determining the effect of the tree structure on the final form of the tree entropy. As described below, in certain implementations, setting all node costs to one (=1) may reduce the results to Shannon entropy, while other cost functions may allow a tree entropy formulation to satisfy additional tree-specific desiderata.

Several axioms associated with tree entropy will now be introduced. It may not be immediately clear why R1 and R2 are the “right” rules to use in order to define tree entropy. However, as will be shown, they arise as consequences of Shannon's original axioms on entropy, modified to handle hierarchical structures, such as, e.g., trees.

Shannon's seminal paper (e.g., C. E. Shannon. A mathematical theory of communication. Bell System Technical Journal, 27:379-423, 1948) gave three desiderata, from which the uniqueness (up to a constant factor) of informational entropy was derived. Firstly, the entropy will be a continuous function in the pᵢ. Secondly, if there are n possible outcomes, all of which are equally likely (e.g., pᵢ=1/n for all i), then the entropy is monotonically increasing in n. Thirdly, let Π be a partition of the possible outcomes, and for each IεΠ, let p̅₁ be p̅ restricted to the coordinates in I, with all other coordinates set to 0, and let q₁ be the sum of the entries of p̅_{I}. Then,

$${H}_{1} ( \overline{p} ) = {H}_{1} ( \overline{q} ) + {\sum }_{I ∈ Π} {q}_{I} {H}_{1} ( {\overline{p}}_{I} ) .$$

It will now be shown that one may model requirements after these conditions, and establish a recursive definition of tree entropy. Here, one may use the first condition essentially without modification and alter the second and third conditions to respect an underlying hierarchical structure (e.g., of the tree, etc.). For the second condition, one may modify it by restricting attention to leaf nodes that are siblings of each other. In a modification of the third condition, to respect the hierarchical structure, one may restrict the set of allowable partitions; for example to only allow partitions that do not “cross” sub-tree boundaries.

Formally, given a tree T, and a partition Π of the leaf nodes of T, it may be said that Π respects T, if for every IεΠ, there is a sub-tree of T, denoted T₁, whose leaf nodes are a superset of I, and for every I, JεΠ, the sub-trees T₁ and T_{J} do not intersect unless T_{I}=T_{J}. If, for example, p was the probability distribution on the leaf nodes of T, we define p̅_{I} and q₁ as above. One may define p_{Π}=(q₁)_{IεΠ}. One may also define T_{Π} as follows. For each IεΠ, create node u₁; add u₁ and set π(u₁) to be the root of T_{I}; then remove all nodes in T_{I} other than its root. Note that, in this example, p_{Π} is the probability vector associated with the leaf nodes of T_{Π}.

One may then establish the following:
Axiom 1. Continuity. H(T, p̅) is continuous in each pᵢ.
Axiom 2. More outcomes, increases uncertainty. Let u be the parent of a leaf node of T, such that u has at least k+1 children. Suppose that for all children ν of u, either p_{ν}=0 or p_{ν}=pᵤ/k. Let r̅ be a new vector such that rᵤ=pᵤ, for all νεC(u), r_{ν}=p_{ν}, and for all νεC(u), either r_{ν}=0 or r_{ν}=rᵤ/(k+1). Then H(T, r̅)>H(T, p̅).
Axiom 3. Additivity over sub-trees. Let Π be a partition of the leaf nodes of T that respects T. Let T_{Π}, p̅ᵢ and p_{Π=(q}_{I})_{IεΠ} be defined as above. Then,

$$H ( T , \overline{p} ) = H ( {T}_{Π} , {\overline{p}}_{Π} ) + {\sum }_{I ∈ Π} {q}_{I} H ( {T}_{I} , {\overline{p}}_{I} ) .$$

One may also use the following axioms, which consider an underlying weighted-tree structure.
Axiom 4. Empty nodes do not matter. Suppose T′ is formed from T by removing some subset of nodes u for which pᵤ=0. Then, H(T′, p̅)=H(T, p̅).
Axiom 5. Scaling due to node cost. Let T_{α} be the tree created by setting c_{Tα} (ν)=αc_{T}(ν) for all ν. Then, H(T_{α}, p̅)=αH(T, p̅).

It will now be considered how one may derive the recursive definition postulates R1 and R2 from these axioms. Observe that encoded in R1, is the notion that for “flat” trees, the standard Shannon entropy and tree entropy are the same. More concretely, let Sₙ denote the rooted star graph on n+1 nodes, which consists of a root with n children, each of which is a leaf node. Let S₀ be the tree consisting of a single node. Then Axiom 3 using tree Sₙ is precisely the same as Shannon's third condition, as all partitions of the leaf nodes respect Sₙ. Furthermore, using tree Sₘ (for m very large), and utilizing Axiom 4, one may see that Axiom 2 yields Shannon's second condition. Hence, in fact tree entropy on Sₙ will be precisely Shannon entropy (up to a constant factor). Axiom 5 shows that this constant may be proportional to c(Sₙ). For convenience, it will be assumed that it is precisely c(Sₙ). Hence, this presents the base case R1.

With regard to the recursive case, suppose the root of T has children u₁, . . . , uₖ, and let Tᵢ denote the sub-tree rooted at uᵢ, for each iε[k]. Define Π to be the partition of the leaf nodes of T whose i^{th} piece consists of the leaf nodes of sub-tree Tᵢ. Applying Axiom 3, one finds that

$$H ( T , \overline{p} ) = H ( {T}_{Π} , {\overline{p}}_{Π} ) + {\sum }_{i ∈ [ k ]} {p}_{{u}_{i}} H ( {T}_{i} , \overline{p} ) .$$

Applying Axiom 3 again, this time to T_{Π}, with partition P′ that-puts each leaf node into a separate class. This time, one finds that H(T, p̅_{Π})=H(Sₖ, p̅_{Π})+0.

Combining these two leads to the recursive hypothesis R2.

It is next shown that for every cost function c(·), there is a unique tree entropy function that satisfies R1 and R2. For every distribution on the leaf nodes of a given tree, this function agrees with the Shannon entropy when the cost function is equal to 1 for all nodes.

Let T be a tree with root r, the set of leaf nodes l(T) and cost function c(·). For simplicity, we let V(T)\{r} be denoted as V _{r̅}.
Theorem 1: The unique function satisfying R1 and R2 is

$$\begin{matrix}H ( T , \overline{p} ) = \frac{1}{{p}_{T}} {\sum }_{v ∈ {V}_{\overline{r}}} c ( π ( v ) ) {p}_{v} l g ( \frac{{p}_{π ( v )}}{{p}_{v}} ) \\ = - {\sum }_{v ∈ {V}_{\overline{r}} - l ( T )} ( c ( π ( v ) ) - c ( v ) ) ( \frac{{p}_{v}}{{p}_{T}} ) l g ( \frac{{p}_{v}}{{p}_{T}} ) - \\ {\sum }_{v ∈ l ( T )} c ( π ( v ) ) ( \frac{{p}_{v}}{{p}_{T}} ) l g ( \frac{{p}_{v}}{{p}_{T}} ) \\ = - {\sum }_{v ∈ {V}_{\overline{r}}} w ( v ) ( \frac{{p}_{v}}{{p}_{T}} ) l g ( \frac{{p}_{v}}{{p}_{T}} )\end{matrix} \qquad \begin{matrix}( 2 ) \\ \\ \\ ( 3 ) \\ \\ \\ \\ ( 4 ) \\ \end{matrix}$$

where w(ν)=c(π(ν)) if ν is a leaf node, and w(ν)=c(π(ν))−c(ν) otherwise.

The above theorem exposes two different viewpoints of the same concept. First, tree entropy is shown to depend on the relative probabilities of a (parent, child) pair in Equation (2), weighted by the parent cost (e.g., dependency data). Apart from the cost, this differs from Shannon entropy in a critical way: the probability of a node v is considered only with respect to that of its parent, instead of the total probability over all leaf nodes. This is what accounts for the dependencies that are induced by the hierarchy.

The second viewpoint shows that tree entropy presents a weighted version of entropy, wherein the weights w(ν) depend on the costs of both the node and its parent in Equation (4). Thus, the dependencies induced by the hierarchy are taken into account in the weighting parameters instead of in the probabilities.

As a further illustration of tree entropy as measurable, for example, using Equation (4) as shown above, consider the following example based, at least in part, on the exemplary distributions for items 600 and 602 presented in FIG. 6.

With regard to item 600, dependency data for the “North” inner node may be based, at least in part, on the sum of either the distribution data and/or established dependency data for its children nodes. Here, for example, the children nodes, “San Francisco” and “San Jose”, are both leaf nodes and as such their distribution data may be used to establish dependency data for the North node (e.g., equal to 0.4+0.5=0.9).

Similarly, dependency data for the “South” inner node may be based, at least in part, on the sum of either the distribution data and/or established dependency data for its children nodes. Here, for example, the children nodes, “San Diego” and “Los Angeles”, are both leaf nodes and as such their distribution data may be used to establish dependency data for the South node (e.g., equal to 0.05+0.05=0.10).

Based, at least in part, on such distribution data and established dependency data, Equation (4) for example, may be applied to determine a tree entropy value for item 600. At least one weighting parameter may also be applied to further modify all or part of the established dependency data. Thus, the tree entropy value may, for example, be calculated by performing the summation process per Equation (4) which would sum together the distribution data and dependency data for each node in the tree as determined by various multiplication and logarithmic functions. Here, for example, assuming a weighting parameter of 1, the summation may include:

(1×0.4)log 0.4≈−0.16 (for the San Francisco leaf node),

(1×0.5)log 0.5≈−0.15 (for the San Jose leaf node),

(1×0.05)log 0.05≈−0.07 (for the San Diego leaf node),

(1×0.05)log 0.05≈−0.07 (for the Los Angeles leaf node),

(1×0.9)log 0.9≈−0.04 (for the North inner node),

(1×0.10)log 0.10≈−0.1 (for the South inner node), and

when summed together and multiplied by (−1) produces a tree entropy value of ≈0.59 for item 600.

Similarly, with regard to item 602, assuming a weighting parameter of 1, the summation may include:

(1×0.4)log 0.4≈−0.16 (for the San Francisco leaf node),

(1×0.1)log 0.1≈−0.1 (for the San Jose leaf node),

(1×0.4)log 0.4≈−0.16 (for the San Diego leaf node),

(1×0.1)log 0.1≈−0.1 (for the Los Angeles leaf node),

(1×0.5)log 0.5≈−0.15 (for the North inner node),

(1×0.5)log 0.5≈−0.15 (for the South inner node), and

when summed together and multiplied by (−1) produces a tree entropy value of ≈0.82 for item 602.

Thus, as this example illustrates, based, at least in part, on the tree entropy values measured above, item 600 with a tree entropy value of ≈0.59 appears to be more focused than does item 602 with a tree entropy value of ≈0.82.

A proof of theorem 1 is as follows. For all trees T, define

$$h ( T , \overline{p} ) = \frac{1}{{p}_{T}} {\sum }_{v ∈ {V}_{\overline{r}}} c ( π ( v ) ) {p}_{v} lg ( \frac{{p}_{π ( v )}}{{p}_{T}} ) .$$

Next, it will be shown that h(T, p̅) satisfies R1 and R2, and then uniqueness will be shown; therefore H(T, p̅)=h(T, p̅).

Notice that,

$$h ( {S}_{n} , \overline{p} ) = \frac{1}{{p}_{{S}_{n}}} {\sum }_{v ∈ l ( {S}_{n} )} c ( {S}_{n} ) {p}_{v} lg ( \frac{{p}_{{S}_{n}}}{{p}_{v}} ) = c ( {S}_{n} ) {H}_{1} ( \overline{p} )$$

satisfies R1.

Next, let T be an arbitrary tree with root 7 and cost function c. Let u_{I}, . . . , uₖ denote the children of r, and let Tᵢ denote the sub-tree of T rooted at uᵢ for each iε[k]. As before, let V _{r̅} be the set of nodes of T without r, and let Vᵢ denote the set of nodes of Tᵢ without uᵢ for iε[k]. Thus,

$$\begin{matrix}\frac{1}{{p}_{T}} {\sum }_{i = 1}^{k} {p}_{{u}_{i}} h ( {T}_{i} , \overline{p} ) = \frac{1}{{p}_{T}} {\sum }_{i = 1}^{k} \frac{{p}_{{u}_{i}}}{{p}_{{u}_{i}}} {\sum }_{v ∈ {V}_{i}} c ( π ( v ) ) {p}_{v} lg ( \frac{{p}_{π ( v )}}{{p}_{v}} ) \\ = \frac{1}{{p}_{T}} {\sum }_{v ∈ {V}_{\overline{r}}} c ( π ( v ) ) {p}_{v} lg ( \frac{{p}_{π ( v )}}{{p}_{v}} ) - \\ \frac{1}{{p}_{T}} {\sum }_{i = 1}^{k} c ( π ( {u}_{i} ) ) {p}_{{u}_{i}} lg ( \frac{{p}_{π ( {u}_{i} )}}{{p}_{{u}_{i}}} ) \\ = h ( T , \overline{p} ) - \frac{1}{{p}_{T}} {\sum }_{i = 1}^{k} c ( T ) {p}_{{u}_{i}} lg ( \frac{{p}_{T}}{{p}_{{u}_{i}}} ) \\ = h ( T , \overline{p} ) - h ( {S}_{k} , \overline{q} )\end{matrix}$$

where Sₖ, the star with k leaf nodes, is the subgraph of T restricted to the root and its children with the natural cost function c(Sₖ)=c(T), and q=(pᵤ_{₁}, . . . pᵤ_{ₖ}). Rearranging, one may note that

$$h ( T , \overline{p} ) = h ( {S}_{k} , \overline{q} ) + \frac{1}{{p}_{T}} {\sum }_{i = 1}^{k} {p}_{{u}_{i}} h ( {T}_{i} , \overline{p} ) .$$

Thus, R2 is satisfied. Hence, the function h(T, p̅) satisfies both R1 and R2.

It will next be shown that h(·,·) is the unique function satisfying R1 and R2. To this end, suppose that g(·,·) is another function satisfying R1 and R2. Since any function satisfying R1 and R2 must satisfy Equation (1),

$$g ( T , \overline{p} ) = - c ( T ) {\sum }_{i ∈ [ k ]} \frac{{p}_{{u}_{i}}}{{p}_{T}} lg ( \frac{{p}_{{u}_{i}}}{{p}_{T}} ) + {\sum }_{i ∈ [ k ]} \frac{{p}_{{u}_{i}}}{{p}_{T}} g ( {T}_{i} , \overline{p} ) ,$$

where uᵢ and Tᵢ are as above. Now, define Δ(T, p̅)=h(T, p̅)−g(T, p̅). Hence,

$$\begin{matrix}Δ ( T , \overline{p} ) = h ( T , \overline{p} ) - g ( T , \overline{p} ) \\ = {\sum }_{i ∈ [ k ]} \frac{{p}_{{u}_{i}}}{{p}_{T}} ( h ( {T}_{i} , \overline{p} ) - g ( {T}_{i} , \overline{p} ) ) \\ = {\sum }_{i ∈ [ k ]} \frac{{p}_{{u}_{i}}}{{p}_{T}} Δ ( T , \overline{p} ) .\end{matrix}$$

By R1, since h and g agree on every star graph Sₙ, Δ(Sₙ, p̅)=h(Sₙ, \vec{p})−g(Sₙ, \vec{p})=0 for all n. Starting from the leaf nodes of the tree and using the above recurrence, one may note that Δ(T, p̅) will be identically 0, for all trees and all p̅. That is, g(T, p̅)=h(T, p̅) for all trees and for all p̅. So h(·,·) is the unique function satisfying R1 and R2.

It is shown next that (3) follows from

$$\begin{matrix} {\sum }_{v ∈ {V}_{\overline{r}}} c ( π ( v ) ) {p}_{v} lg ( \frac{{p}_{π ( v )}}{{p}_{v}} ) \\ = {\sum }_{v ∈ \{ r \} ⋃ {V}_{\overline{r}} - l ( T )} {\sum }_{α ∈ C ( v )} c ( π ( α ) ) {p}_{α} lg ( \frac{{p}_{π ( α )}}{{p}_{T}} ) \\ = {\sum }_{v ∈ \{ r \} ⋃ {V}_{\overline{r}} - l ( T )} c ( v ) lg ( \frac{{p}_{v}}{{p}_{T}} ) {\sum }_{α ∈ C ( v )} {p}_{α} \\ = c ( T ) {p}_{T} lg ( \frac{{p}_{T}}{{p}_{T}} ) + {\sum }_{v ∈ {V}_{\overline{r}} - l ( T )} c ( v ) {p}_{v} lg ( \frac{{p}_{v}}{{p}_{T}} ) \\ = {\sum }_{v ∈ {V}_{\overline{r}} - l ( T )} c ( v ) {p}_{v} lg ( \frac{{p}_{v}}{{p}_{T}} ) .\end{matrix}$$

Hence,

$$h ( T , \overline{p} ) = \frac{1}{{p}_{T}} {\sum }_{v ∈ {V}_{\overline{r}}} c ( π ( v ) ) {p}_{v} lg ( \frac{{p}_{π ( v )}}{{p}_{v}} )$$

Equation (4) follows from (3) by definition.

In this section some exemplary properties that may be satisfied by tree entropy are shown. First, the definition of tree entropy trivially includes Shannon entropy as a special case. The next property notes that because of the normalization in the definition of tree entropy, H(T, p̅) is independent of p_{T}, the total weight of the probability distribution. Property 4 (presented below) notes that homeomorphic trees have the same tree entropy. The last property extends the concavity of the Shannon entropy to tree entropy.
Property 2: If c(ν)=1 for all nodes, then H(T, p̅)=H₁( p̅).
   Thus, Shannon entropy may be considered a special case of tree entropy, where all nodes are weighted equally.
Property 3: Let T be a tree, let β>0 be a constant, and let p̅ be a vector, all of whose components are non-negative. Then, H(T, p̅)=H(T, β p̅).
Property 4: Let T be a tree with cost function c(·) that has a node x with child y. Form tree T′ by taking tree T, removing edge (x,y), and inserting edges (x,y′) and (y′,y) where y′ is a new node (e.g., such that y is a child of y′, which is a child of x). Let the cost function for T′ be c′(·), which is defined by c′(ν)=c(ν) for all nodes ν in T, and c′(y′) may be any value.

Then H(T, p̅)=H₁(T′, p̅) for all p̅.

This may be proven as follows. Let V _{r̅} be the node set of T without the root, and let V′=V _{r̅}∪{y′}. Notice that for all nodes ν in tree T, it is the case that p_{ν} for T is exactly the same as p_{ν} for T′. Consequently, there is no ambiguity in our notation. Further, since y′ has exactly one child, p_{y′}=p_{y}. Hence,

$$\begin{matrix}H ( T , \overline{p} ) = \frac{1}{{p}_{T}} {\sum }_{v ∈ {V}_{\overline{r}}} c ( π ( v ) ) {p}_{v} lg ( \frac{{p}_{π ( v )}}{{p}_{v}} ) \\ = \frac{1}{{p}_{T}} {\sum }_{v ∈ {V}_{\overline{r}} - ( y )} c ( π ( v ) ) {p}_{v} lg ( \frac{{p}_{π ( v )}}{{p}_{y}} ) + c ( x ) \frac{{p}_{y}}{{p}_{T}} lg ( \frac{{p}_{x}}{{p}_{y}} ) \\ = \frac{1}{{p}_{T}} {\sum }_{v ∈ {V}_{\overline{r}} - \{ y \}} ( c ( π ( v ) ) {p}_{v} lg ( \frac{{p}_{π ( v )}}{{p}_{v}} ) + c ( x ) \frac{{p}_{{y}^{′}}}{{p}_{T}} lg ( \frac{{p}_{x}}{{p}_{{y}^{′}}} ) + \\ c ( {y}^{′} ) \frac{{p}_{y}}{{p}_{T}} lg ( \frac{{p}_{{y}^{′}}}{{p}_{y}} ) ) \\ = \frac{1}{{p}_{T}^{′}} {\sum }_{v ∈ {V}^{′}} c ( π ( v ) ) {p}_{v} lg ( \frac{{p}_{π ( v )}}{{p}_{v}} ) = H ( {T}^{′} , \overline{p} ) .\end{matrix}$$

Using the above property, one may extend the tree so that every leaf node is at the same depth, without changing the tree entropy. Thus, one may assume that such trees are leveled.
Property 5: If c(π(ν))≧c(ν) for all nodes ν in tree T, and c(π(ν))≧0 for all leaf nodes ν of T, then for fixed p_{T}, H(T, p̅) is a concave function of p̅.

This may be proven as follows. From Theorem 1,

$$H ( T , \overline{p} ) = - {\sum }_{v ∈ {V}_{\overline{r}}} w ( v ) ( \frac{{p}_{v}}{{p}_{T}} ) lg ( \frac{{p}_{v}}{{p}_{T}} ) ,$$

and by an assumption, w(ν)≧0. Let χ_{ν} be the vector with entries 1/p_{T} corresponding to the leaf nodes in the sub-tree rooted at ν, and 0 for all other leaf nodes. Each term in the sum is of the form f( p̅)=−y log y, where y=p_{ν}/p_{T}=χ_{ν}^{T} p̅ is a linear function of p for fixed p_{T}. Since affine transformations preserve concavity (the matrix ∇²f( p̅)=f″(χ_{ν}^{T} p̅)χ_{ν}^{T} is negative semi-definite since f(y)=−y log y is concave on y>0), each term in the sum is a jointly) concave function of p̅, and so the weighted sum, with nonnegative weights w(ν), is concave as well.

Examples may be constructed to show that if p_{T} is not a constant, H(T, p̅) is not a concave function of p̅, so that the condition that p_{T} be fixed is necessary for concavity.

In this section some exemplary techniques are presented that may be used, for example, in choosing a cost function. The definition of tree entropy presented in the examples above assumes an intrinsic cost function associated with the tree. In these non-limiting examples, the only condition that has been imposed on such exemplary cost functions was that cost of a node be greater than or equal to that of its children (c(π(ν))≧c(ν)), in order to ensure concavity of the tree entropy (e.g., see Property 5). In this section, some other exemplary properties are presented that tree entropy may satisfy and/or which may drive a choice of an appropriate cost function should one be desired.

Over all probability distributions p̅εR″, the Shannon entropy may be maximized for

$$\overline{p} = ( \frac{1}{n} , … , \frac{1}{n} ) ,$$

the distribution that corresponds to a maximum uncertainty. For tree entropy, however, a distribution at which tree entropy is maximized for a given tree depends not only on the tree structure but also the cost function c(·). In certain implementations one may, for example, decide to impose conditions on a cost function such that tree entropy is maximized for distributions corresponding to “maximum uncertainty” for the given tree structure.

One may start with the simple case when T is a leveled k-ary tree with n leaf nodes. For this exemplary tree, it may be assumed that the distribution with maximum uncertainty is the uniform distribution on the leaf nodes.

Assume that the probability distribution p̅ on T satisfies p_{T}=1. Let d(ν) be the depth of any node ν (e.g., the distance of ν from the root). Let d(T) be the depth of the tree. Then, for the cost function c(ν)=d(T)−d(ν)−1, the tree entropy is

$$H ( T , \overline{p} ) = - {\sum }_{v ∈ {V}_{\overline{r}}} {p}_{v} lg {p}_{v} .$$

The sum of p_{ν} over all nodes ν at the same depth from the root is 1 (since p_{T}=1), so that these numbers form a probability distribution for each level. The above expression may therefore be written as the sum of the Shannon entropies of the probability distributions at each level. The Shannon entropy may be maximized by the uniform distribution, so tree entropy for such a cost function may be maximized by the distribution

$$\overline{p} = ( \frac{1}{n} , … , \frac{1}{n} )$$

since this distribution leads to a uniform distribution at every level in the tree.

The above argument depended on the fact that the tree was a leveled, k-ary tree. Next leveled trees are considered, which are not necessarily k-ary. It is first shown that distribution on the leaf nodes corresponds to “maximum uncertainty”.

At any node νεV(T), the weight distribution among the children of ν may be maximally uncertain, or most non-coherent, if all the children of ν have equal weights. Labeling the n leaf nodes of T with numbers 1, . . . , n, one may recursively define a probability distribution p̅ₘₐₓ^{T}εR″ on the leaf nodes as follows. With r the root, let r=ν₀, ν₁, . . . , ν_{d}=i be the unique path from the root to leaf i. Then the i^{th} entry of

$${\overline{p}}_{max}^{T} is {\prod }_{i = 0}^{d - 1} {b ( {v}_{i} )}^{- 1} ,$$

where b(ν) is the number of children of node ν. If the root of T has k children u₁, . . . , uₖ, then pᵤ_{ᵢ}=1/k for all iε[k], according to p̅ₘₐₓ^{T}. Also, if Tᵢ is the sub-tree rooted at uᵢ, then p̅ₘₐₓ^{T}^{ᵢ}, the distribution with maximum uncertainty for Tᵢ, is k times the corresponding component of the vector p̅ₘₐₓ^{T}, so that H(Tᵢ, p̅ₘₐₓ^{T}^{ᵢ})=H(Tᵢ, k p̅ₘₐₓ^{T})=H(Tᵢ, p̅ₘₐₓ^{T}).

It is now considered what conditions one may we impose on a cost function so that the distribution p̅ₘₐₓ^{T} is the one with the highest entropy, e.g., so that H(T, p̅) is maximized at p̅= p̅ₘₐₓ^{T}.

Let Hₘₐₓ(T)=max _{p̅}H(T, p̅). From Property 3, Hₘₐₓ(T) does not depend on p_{T}, and hence p_{T}=1 without loss of generality. As before, let the children of the root be of u₁, . . . , uₖ, and let tree Tᵢ be rooted at uᵢ. From Equation (1), thus

$$H ( T , \overline{p} ) = - c ( T ) {\sum }_{i ∈ [ k ]} {q}_{i} lg {q}_{i} + {\sum }_{i ∈ [ k ]} {q}_{i} H ( {T}_{i} , \overline{p} ) ,$$

where q₁=pᵤ_{ⁱ} for each iε[k]. Hence,

$${H}_{max} ( T ) = {max}_{\overline{p}} \{ - c ( T ) {\sum }_{i ∈ [ k ]} {q}_{i} lg {q}_{i} + {\sum }_{i ∈ [ k ]} {q}_{i} H ( {T}_{i} , \overline{p} ) \} .$$

Thus, for example, consider H(Tᵢ, p̅). Once the values of qᵢ=p_{T}_{ᵢ} have been chosen, the maximum value of H(Tᵢ, \vec{p}) is 0 if qᵢ=0, and is precisely Hₘₐₓ(Tᵢ) if qᵢ>0, by Corollary 3. That is, qᵢH(Tᵢ, \vec{p}) is at most qᵢHₘₐₓ(Tᵢ). Further, since each H(Tᵢ, p̅) relies on a disjoint set of values of p̅, and the rest of the expression one may, for example, seek to maximize is independent of p̅ (once the qᵢ values have been chosen), each qᵢH(Tᵢ, \vec{p}) may actually obtain this maximum. Hence,

$${H}_{max} ( T ) = {max}_{\overline{q}} \{ - c ( T ) {\sum }_{i ∈ [ k ]} {q}_{i} lg {q}_{i} + {\sum }_{i ∈ [ k ]} {q}_{i} {H}_{max} ( {T}_{i} ) \} \qquad ( 5 )$$

where the maximum is taken over all q̅ of k−1 components, and qₖ is defined to be 1−qᵢ− . . . −qₖ₋₁. Using this equation, one may show the following result.
Theorem 6: Let T be a tree with root r and cost function c(·), and suppose that c(ν)≧0 for all nodes ν. Then the following are equivalent:
1. Hₘₐₓ(T)=H(T, p̅ₘₐₓ^{T}).
2. For every pair of sub-trees U,V of T whose roots are siblings of each other, we have Hₘₐₓ(U)=Hₘₐₓ(V).
3. For every path r=ν₀, ν₁, . . . , ν_{d} from the root of T to a leaf of T, the value

$${\sum }_{i = 0}^{d - 1} c ( {v}_{i} ) lg b ( {v}_{i} )$$

is the same.

If any of the above holds, then

$${H}_{max} ( T ) = {\sum }_{i = 0}^{d - 1} c ( {v}_{i} ) lg b ( {v}_{i} )$$

for any path r=ν₀, . . . , ν_{d} from r to a leaf of T.

Here is another way to understand this result. Let T₁ and T₂ be two sub-trees in T whose roots are siblings. The formula for Hₘₐₓ(T) and the associated condition on the cost function says that even if the average branching factor in T₁ is much larger than that of T₂, both T₁ and T₂ contribute equally to the maximum entropy. In terms of the taxonomy, this means, for example, that at any level of the hierarchy, each node (e.g., an aggregated class) captures the same amount of “uncertainty” (or information) about the item. The fact that T₁ has larger branching factor on average only means that on average, the mutual coherence of two siblings in T₁ is much less than the mutual coherence of siblings in T₂, e.g., T₁ makes much finer distinction between classes than T₂.

This may be seen mathematically as follows. Define c′(ν)=c(ν)1g b(ν). Then condition (3) of Theorem 6 says that

$${\sum }_{i = 0}^{d - 1} {c}^{′} ( {v}_{i} )$$

is the same over all paths. By Theorem 1, the formula for tree entropy becomes

$$\begin{matrix}H ( T , \overline{p} ) = \frac{1}{{p}_{T}} {\sum }_{v ∈ {V}_{\overline{r}}} \frac{{c}^{′} ( π ( v ) )}{lg b ( π ( v ) )} {p}_{v} lg ( \frac{{p}_{π ( v )}}{{p}_{v}} ) \\ = \frac{1}{{p}_{T}} {\sum }_{v ∈ {V}_{\overline{r}}} {c}^{′} ( π ( v ) ) {p}_{v} {lg}_{b ( π ( v ) )} ( \frac{{p}_{π ( v )}}{{p}_{v}} ) .\end{matrix}$$

In other words, the base of the logarithm is now the branching factor of the parent, reflecting the fact that one may be as uncertain at nodes with high branching factor as over small ones. Another view is that when one encodes messages, one may use a larger alphabet when the branching factor is larger.

Note that, if a node has two (or more) sub-trees, one of which is a leaf node, then condition (3) of Theorem 6 cannot hold unless all of the sub-trees are leaf nodes. Further, if the branching factor at a node, b(ν) is 1, then 1g b(ν)=0. Hence, simply extending the leaf node by adding an edge to it cannot solve the problem (since it does not change the sum in condition (3)). In fact, given T, let T′ be the unique graph with the smallest number of edges, over all graphs homeomorphic to T. Then if one of the leaf nodes of T′ has no siblings, then there is no cost function satisfying the theorem. In those cases, it may make sense to redefine where the maximum tree entropy occurs, by ignoring those “only-children leaf nodes.” On the other hand, if all leaf nodes of T′ have siblings, then there should be no such problem.

A proof of Theorem 6 will now be presented. Throughout, suppose that T has k children u₁, . . . , uₖ, and Tᵢ is the sub-tree rooted at uᵢ for iε[k]. We let qᵢ=pᵤ_{ᵢ} for iε[k].

First, suppose that condition (1) holds. It may be shown that condition (2) must hold as well, by induction on the height of T. The base case, when T has height 1, follows naturally. So consider a general tree T.

Let,

$$f ( {q}_{1} , … , {q}_{k - 1} ) = - c ( T ) {\sum }_{i ∈ [ k ]} {q}_{i} lg {q}_{i} + {\sum }_{i ∈ [ k ]} {q}_{i} {H}_{max} ( {T}_{i} ) , \\ with {q}_{k} = 1 - {q}_{1} - … - {q}_{k - 1} .$$

By Equation (5), Hₘₐₓ(T)=max _{q̅}f( q̅).

One may take a partial derivative of f with respect to q₁ for t<k. Recall that

$${q}_{k} = 1 - {q}_{1} - … - {q}_{k - 1} , hence \frac{\partial {q}_{k}}{\partial {q}_{t}} = - 1.$$

### Thus,

$$\begin{matrix}\frac{\partial f}{\partial {q}_{l}} = - c ( T ) [ lg {q}_{l} + lg e - lg {q}_{k} - lg e ] + \\ {H}_{max} ( {T}_{l} ) - {H}_{max} ( {T}_{k} ) \\ = c ( T ) [ lg {q}_{k} - lg {q}_{l} ] + {H}_{max} ( {T}_{l} ) - {H}_{max} ( {T}_{k} )\end{matrix}$$

Since c(T)≧0, f is a convex function. Hence, f is maximized at the point that all of its partial derivatives are 0. But since condition (1) holds, that will be when p̅= p̅ₘₐₓ^{T}. That is, q₁=1/k for all tε[k]. So at this point,

0=c(T)[−1g k+1g k]+Hₘₐₓ(Tᵢ)−Hₘₐₓ(Tₖ).

That is, Hₘₐₓ(Tₜ)=Hₘₐₓ(Tₖ). Since this is true for all t, one may see that Hₘₐₓ(Tᵢ)=Hₘₐₓ(Tⱼ) for all i,jε[k]. Hence by Equation (5), for any lε[k]

Hₘₐₓ(T)=c(T)1g k+Hₘₐₓ(Tₗ) (6).

Recall Equation (1):

$$H ( T , \overline{p} ) = - c ( T ) {\sum }_{i ∈ [ k ]} \frac{{p}_{{u}_{i}}}{{p}_{T}} lg ( \frac{{p}_{{u}_{i}}}{{p}_{T}} ) + {\sum }_{i ∈ [ k ]} \frac{{p}_{{u}_{i}}}{{p}_{T}} H ( {T}_{i} , \overline{p} ) .$$

Substitute p̅= p̅ₘₐₓ^{T} into the above equation. By condition (1), one may see that,

$${H}_{max} ( T ) = c ( T ) {\sum }_{i ∈ [ k ]} \frac{1}{k} lg k + {\sum }_{i ∈ [ k ]} \frac{1}{k} H ( {T}_{i} , {\overline{p}}_{max}^{T} ) .$$

Combining this with Equation (6), one may see that,

$${\sum }_{i ∈ [ k ]} \frac{1}{k} H ( {T}_{i} , {\overline{p}}_{max}^{T} ) = {H}_{max} ( {T}_{l} ) .$$

Hence, H(Tₗ, p̅ₘₐₓ^{T})=Hₘₐₓ(Tₗ). But by definition, H(Tₗ, p̅ₘₐₓ^{T}^{ₗ})=H(Tₗ, k p̅ₘₐₓ^{T})=H(Tₗ, p̅ₘₐₓ^{T}). That is, H(Tₗ, p̅ₘₐₓ^{T}^{ₗ})=Hₘₐₓ(Tₗ). So by induction, every pair of sub-trees U, V of Tₗ whose roots are siblings are such that Hₘₐₓ(U)=Hₘₐₓ(V). Since this is true for all l, and Hₘₐₓ(Tᵢ)=Hₘₐₓ(Tⱼ) for all i,jε[k], one may see that condition (2) follows.

Now assume condition (2) holds. It may be shown that condition (1) must hold, by induction on the height of T. The base case, for T consisting of a single node, follows naturally. So consider a general T.

Let f be as above. Again,

$$\frac{\partial f}{\partial {q}_{l}} = c ( T ) [ lg {q}_{k} - lg {q}_{l} ] + {H}_{max} ( {T}_{l} ) - {H}_{max} ( {T}_{k} )$$

By condition (2), Hₘₐₓ(Tₜ)=Hₘₐₓ(Tₖ) for all tε[k]. Hence,

$$\frac{\partial f}{\partial {q}_{l}} = 0$$

if and only if qₜ=qₖ. That is, all the partial derivatives of f are 0 only when qᵢ=1/k for all iε[k]. Since c(T)≧0, f is convex. So the unique maximum of f occurs at this point. Again, by Equation (5), one may have that Hₘₐₓ(T)=max _{q̅}f (\vec{q}). Hence, H(T, p̅) is maximized when pᵤ_{ᵢ}=qᵢ=1/k for all iε[k]. So one may see,

$${H}_{max} ( T ) = c ( T ) lg k + { \sum }_{i ∈ [ k ]} \frac{1}{k} {H}_{max} ( {T}_{i} ) .$$

By induction, one may have that Hₘₐₓ(Tᵢ)=Hₘₐₓ(Tᵢ, p̅ₘₐₓ^{T}^{ᵢ}) for all iε[k]i □[k]. Hence,

$$\begin{matrix}{H}_{max} ( T ) = c ( T ) lg k + { \sum }_{i ∈ [ k ]} \frac{1}{k} {H}_{max} ( {T}_{i} , {\overline{p}}_{max}^{{T}_{i}} ) \\ = c ( T ) lg k + {\sum }_{i ∈ [ k ]} \frac{1}{k} H ( {T}_{i} , k {\overline{p}}_{max}^{T} ) \\ = c ( T ) lg k + {\sum }_{i ∈ [ k ]} \frac{1}{k} H ( {T}_{i} , {\overline{p}}_{max}^{T} ) \\ = H ( T , {\overline{p}}_{max}^{T} ) .\end{matrix}$$

Now, suppose that condition (1) holds. It may be shown that condition (3) holds as well. To do this, one may prove by induction on the height of T that for any path r=ν₀, . . . , ν_{d} from the root of T to a leaf node of T,

$${H}_{max} ( T ) = {\sum }_{i = 0}^{d - 1} c ( {v}_{i} ) lg b ( {v}_{i} ) .$$

The base case is trivial, so consider a general T.

By Equation (6), one may see that Hₘₐₓ(T)=c(ν₀)1g b(ν₀)+Hₘₐₓ(Tₗ).

Choose l such that Tₗ is rooted at node ν₁. Then by induction,

$${H}_{max} ( {T}_{l} ) = {\sum }_{i = 1}^{d - 1} c ( {v}_{i} ) lg b ( {v}_{i} ) .$$

This shows that

$${H}_{max} ( T ) = {\sum }_{i = 0}^{d - 1} c ( {v}_{i} ) lg b ( {v}_{i} ) ,$$

as wanted.

Now, suppose that condition (3) holds. It may again be proven by induction on the height of T that

$${H}_{max} ( T ) = {\sum }_{i = 0}^{d - 1} c ( {v}_{i} ) lg b ( {v}_{i} )$$

for any path r=ν₀, . . . , ν_{d} from r to a leaf node of T. The base case, when T is a single node, follows naturally. So consider a general T.

Let lε[k], and note that for all paths uₗ=ν₁′,ν₂′, . . . , ν_{d}′ from the root to Tₗ to a leaf node of Tₗ, one may have that (from condition (3)),

$$c ( {v}_{0} ) lg b ( {v}_{0} ) + {\sum }_{i = 1}^{d - 1} c ( {v}_{i}^{′} ) lg b ( {v}_{i}^{′} )$$

is the same. Hence,

$${\sum }_{i = 1}^{d - 1} c ( {v}_{i}^{′} ) lg b ( {v}_{i}^{′} )$$

is the same over all such paths. Thus, one may apply an inductive hypothesis to Tₗ. That is,

$${H}_{max} ( {T}_{l} ) = {\sum }_{i = 1}^{d - 1} c ( {v}_{i}^{′} ) lg b ( {v}_{i}^{′} ) .$$

Consider a path r=νₒ, ν₁, . . . , νₜ from r to a leaf of T such that ν₁=uⱼ. Then, by condition (3),

$$c ( {v}_{0} ) + {\sum }_{i = 1}^{t - 1} c ( {v}_{i} ) l g b ( {v}_{i} ) = c ( {v}_{0} ) + {\sum }_{i = 1}^{d - 1} c ( {v}_{i}^{′} ) l g b ( {v}_{i}^{′} ) \\ ⇒ c ( {v}_{0} ) + {H}_{max} ( {T}_{j} ) = c ( {v}_{0} ) + {H}_{max} ( {T}_{𝓁} ) \\ ⇒ {H}_{max} ( {T}_{j} ) = {H}_{max} ( {T}_{𝓁} )$$

That is, Hₘₐₓ(Tⱼ)=Hₘₐₓ(Tₗ), for all j, lε[k]. Hence,

$$\begin{matrix}{H}_{max} ( T ) = {max}_{\overline{q}} \{ - c ( T ) {\sum }_{i ∈ [ k ]} {q}_{i} l g {q}_{i} + {\sum }_{i ∈ [ k ]} {q}_{i} {H}_{max} ( {T}_{i} ) \} \\ = {max}_{\overline{q}} \{ - c ( T ) {\sum }_{i ∈ [ k ]} {q}_{i} l g {q}_{i} + {H}_{max} ( {T}_{j} ) \} \\ = c ( T ) l g k + {H}_{max} ( {T}_{j} ) \\ = c ( T ) l g b ( r ) + {\sum }_{i = 1}^{t - 1} c ( {v}_{i} ) l g b ( {v}_{i} ) .\end{matrix}$$

Let U, V be sub-trees of T with roots x, y, respectively, with x and y siblings. Let r=ν₀, ν₁, . . . , ν_{d}=π(x) be the path from r to the parent of x (which is also the parent of y). Let x=x₀, x₁, . . . , xₛ be a path from x to a leaf node of U, and let y=y₀, y₁, . . . , yₜ be a path from y to a leaf of V. Then, by condition (3) and the claim just proved,

$${\sum }_{i = 0}^{d} c ( {v}_{i} ) l g b ( {v}_{i} ) + {\sum }_{i = 0}^{s - 1} c ( {x}_{i} ) l g b ( {x}_{i} ) = {\sum }_{i = 0}^{d} c ( {v}_{i} ) l g b ( {v}_{i} ) + {\sum }_{i = 0}^{t - 1} c ( {y}_{i} ) l g b ( {y}_{i} ) ⇒ {\sum }_{i = 0}^{s - 1} c ( {x}_{i} ) l g b ( {x}_{i} ) = {\sum }_{i = 0}^{t - 1} c ( {y}_{i} ) l g b ( {y}_{i} ) ⇒ {H}_{max} ( U ) = {H}_{max} ( V ) .$$

Thus, condition (2) follows.

To finish the proof of the theorem, notice that as just showed that condition (3) implies that

$${H}_{max} ( T ) = {\sum }_{i = 0}^{d - 1} c ( {v}_{i} ) l g b ( {v}_{i} )$$

for any path r=ν₀, . . . , ν_{d} from r to a leaf node of T.

It is now shown how one may generalize the notion of KL-divergence (see, e.g., S. Kullback and R. A. Leibler. On information and sufficiency. Annals of Mathematical Statistics, 22:79-86, 1951) to tree entropy; this aspect may be referred to as “tree divergence”.

Since the KL-divergence is a measure of the similarity of two probability distributions over the same alphabet, one may think of tree divergence as dealing with two probability distributions over the same tree with the same cost function. The argument presented here may, for example, be generalized to distributions over different trees; the results are less intuitive.

Recall the KL-divergence can be defined in terms of Bregman divergence (see, e.g., L. M. Bregman. The relaxation method of finding the common points of convex sets and its application to the solution of problems in convex programming. USSR Computational Mathematics and Mathematical Physics, 7:200-217, 1967). For any concave, continuously-differentiable function, f, the Bregman divergence of f, denoted B_{f}(·∥·) is defined as B_{f}( p̅∥ q̅)=f( p̅)−f( q̅)−( q̅)·( p̅− q̅).

The KL-divergence is defined as the Bregman divergence of the entropy function,

$${H}_{1} ( \vec{p} ) = {\sum }_{i} {p}_{i} l g {p}_{i} .$$

Notice that one may assume that

$${\sum }_{i} {p}_{i} = 1 ,$$

an ignore that constraint when taking a derivative.

Likewise, one may define the tree divergence as the Bregman divergence of the tree entropy function, where one may ignore the normalization. Fix a tree T, and denote the tree divergence for tree T by KL_{T}(·∥·). For convenience, assume that

$${\sum }_{i} {p}_{i} = {\sum }_{i} {q}_{i} = 1.$$

Let V _{r̅}be the set of nodes in T without the root, and let w(·) be as in Theorem 1. Define

$$φ ( \overline{p} ) = - {\sum }_{v ∈ {V}_{\overline{r}}} w ( v ) {p}_{v} l g {p}_{v} ,$$

and define KL_{T}( p̅∥ q̅)=B_{φ}( p̅∥ q̅). This leads to the following.
Theorem 7: Let T be a tree, and let V _{r̅}be its node set without the root. Let w(·) be defined as in Theorem 1. Then for

$${\sum }_{i} {p}_{i} = {\sum }_{i} {q}_{i} = 1 ,$$

$$K {L}_{T} ( \vec{p} \vert \vert \vec{q} ) = {\sum }_{v ∈ {V}_{\overline{r}}} w ( v ) {p}_{v} l g ( {q}_{v} / {p}_{v} ) .$$

A proof of Theorem 7 will now be presented. Recall that

$$φ ( \vec{p} ) = - {\sum }_{v ∈ {V}_{\overline{r}}} w ( v ) {p}_{v} l g {p}_{v} .$$

One may first calculate ∇₁₀₀. Recall that if ν lies in the path from the root to leaf node i, then

$$\frac{\partial {q}_{v}}{\partial {q}_{i}} = 1 ,$$

otherwise it is 0. Let pathᵢ be the set of nodes in the path from the root of T to the leaf node i, not including the root itself. One may have that the i^{th} entry of ∇₁₀₀ ( q̅) is

$$\begin{matrix}∇ {φ ( \overline{q} )}_{i} = - {\sum }_{v ∈ {path}_{i}} w ( v ) ( l g {q}_{v} + l g e ) \\ = - {\sum }_{v ∈ {path}_{i}} w ( v ) l g {q}_{v} - c ( T ) l g e\end{matrix}$$

### Hence,

$$\begin{matrix}∇ φ ( \vec{q} ) \cdot ( \vec{p} - \vec{q} ) = - {\sum }_{i ∈ [ n ]} {\sum }_{v ∈ {path}_{i}} w ( v ) ( {p}_{i} - {q}_{i} ) l g {q}_{v} + \\ {\sum }_{i ∈ [ n ]} c ( T ) ( {p}_{i} - {q}_{i} ) l g e \\ = - {\sum }_{v ∈ {V}_{\overline{r}}} w ( v ) ( {p}_{v} - {q}_{v} ) l g {q}_{v} + 0\end{matrix}$$

Thus,

$$\begin{matrix}{B}_{T} ( \vec{p} \vert \vert \vec{q} ) = - {\sum }_{v ∈ {V}_{\overline{r}}} w ( v ) {p}_{v} l g {p}_{v} + {\sum }_{v ∈ {V}_{\overline{r}}} w ( v ) {q}_{v} l g {q}_{v} \\ = {\sum }_{v ∈ {V}_{\overline{r}}} w ( v ) {p}_{v} l g ( {q}_{v} / {p}_{v} ) .\end{matrix}$$

In this section we provide additional interpretation of the definition of tree entropy is presented via an exemplary generative model. Here, it will be assumed that tree T has exactly n leaf nodes and c(T)=1.

First, consider a very straightforward generative model. Starting at the root of T, move to one of its children, with probability of going to child u exactly pᵤ. Once arriving at this new node, go to one of its children, with the probability of going to child ν exactly p_{ν}. Repeat this until a leaf node is reached. At this point, output the name of that node. Repeating this process over and over, it is easy to see that this generates a string of leaf names, with the probability of outputting leaf ν equal to p_{ν}. So the entropy of this sequence is just the Shannon Entropy of the distribution p̅.

One extension of this would be to output the entire path taken. But it is not hard to see that the entropy of the sequence generated in this way is precisely the same as the entropy of the sequence consisting only of leaf names, since each leaf name uniquely determines the path to the root.

Rather than simply outputting the entire path from root to leaf, suppose that it is desired to output, for example,.the fourth node in the path. For instance, in a classifier and taxonomy example, one might desire a classification of the element with some specified level of granularity. Items that are close together in the tree may look identical at coarse levels of granularity, while items that are far from each other in the tree may still be different. More specifically, choose a path as above, e.g., ν₀, ν₁, . . . , ν_{d}, where ν₀ is the root and ν_{d} is a leaf node. Output exactly one of ν₁, . . . , ν_{d}, with the probability of outputting νᵢ equal to w(νᵢ). Recall, that w(νᵢ)=c(νᵢ₋₁)−c(νᵢ) for i<d and w(ν_{d})=c(ν_{d-1}). Notice that, since it was assumed c(T)=1, the sum of these probabilities is exactly 1. Here, for example, when outputting a node name one may also record on which level it is.

Upon transmitting the sequence of node names generated by repeating this process, assuming that both the transmitter and the receiver knows from which level each node name came, leads to the following.
Theorem 8: Tree entropy is the best-case asymptotic rate for this transmittal

Put another way, tree entropy for T is equal to the Shannon entropy of the above sequence, conditioned on knowing the level for the i^{th} node name produced, for all i.

In the foregoing detailed description the notion of entropy of a distribution specified on the leaf nodes of a tree has been systematically developed. As shown, this definition may be a unique solution to a small collection of axioms and may be a strict generalization of Shannon entropy. Tree entropy, for example, may be adapted for a variety of different data processing tasks, such as, data mining applications, including classification, clustering, taxonomy management, and the like.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method for use with at least one computing device, the method comprising:
accessing taxonomic data stored in memory, said taxonomic data being associated with an item as classified into a taxonomy having a hierarchical structure, said taxonomic data comprising at least distribution data associated with a distribution of said item over each one of a plurality of leaf nodes of at least a portion of said hierarchical structure;
establishing dependency data associated with said distribution and each one of a plurality of inner nodes of at least said portion of said hierarchical structure, said inner nodes being superior to said leaf nodes; and
determining entropic data for said item based, at least in part, on said distribution data and said dependency data.

2. The method as recited in claim 1, wherein said distribution comprises a probability distribution.

3. The method as recited in claim 1, wherein said hierarchical structure comprises at least one structure selected from a group of structures comprising a tree and a sub-tree.

4. The method as recited in claim 1, wherein at least a portion of said dependency data comprises weighted dependency data.

5. The method as recited in claim 1, wherein establishing said dependency data further comprises:
applying at least one weighting parameter to at least a portion of said dependency data.

6. The method as recited in claim 5, wherein establishing said dependency data further comprises:
establishing said at least one weighting parameter based, at least in part, on at least one cost function.

7. The method as recited in claim 1, wherein determining said entropic data comprises:
determining a tree entropy value using a tree entropy function.

8. The method as recited in claim 7, further comprising:
determining a tree divergence value based, at least in part, on said tree entropy function, wherein said tree divergence value is associated with said distribution and another distribution associated with another item as classified into said taxonomy.

9. The method as recited in claim 1, further comprising:
identifying said item.

10. The method as recited in claim 1, wherein said item includes at least a portion of at least one item selected from a group of items comprising a web page, a document, a file, a database, an object, a message, and a query.

11. The method as recited in claim 1, further comprising:
establishing said taxonomic data for said item by classifying said item.

12. The method as recited in claim 1, further comprising:
determining a score value for said item based, at least in part, on said entropic data.

13. The method as recited in claim 1, further comprising:
establishing a query response identifying at least said item, said query response being based, at least in part, on at least one value associated with said item selected from a group of values comprising a score value, a tree entropy value, and a tree divergence value.

14. A system comprising:
memory configurable to store taxonomic data, said taxonomic data being associated with an item as classified into a taxonomy having a hierarchical structure, said taxonomic data comprising at least distribution data associated with a distribution of said item over each one of a plurality of leaf nodes of at least a portion of said hierarchical structure; and
at least one processing unit operatively coupled to said memory and configurable to access at least said taxonomic data, establish dependency data associated with said distribution and each one of a plurality of inner nodes of at least said portion of said hierarchical structure, said inner nodes being superior to said leaf nodes, and determine entropic data for said item based, at least in part, on said distribution data and said dependency data.

15. The system as recited in claim 14, wherein said hierarchical structure comprises at least one structure selected from a group of structures comprising a tree and a sub-tree.

16. The system as recited in claim 14, wherein said at least one processing unit is further configurable to apply at least one weighting parameter to at least a portion of said dependency data.

17. The system as recited in claim 16, wherein said at least one processing unit is further configurable to establish said at least one weighting parameter based, at least in part, on at least one cost function.

18. The system as recited in claim 14, wherein said at least one processing unit is further configurable to determine a tree divergence value based, at least in part, on a tree entropy function, wherein said tree divergence value is associated with said distribution and another distribution associated with another item as classified into said taxonomy.

19. A computer program product, comprising:
computer-readable medium comprising instructions for causing at least one processing unit to:
access taxonomic data associated with an item as classified into a taxonomy having a hierarchical structure, said taxonomic data comprising at least distribution data associated with a distribution of said item over each one of a plurality of leaf nodes of at least a portion of said hierarchical structure;
establish dependency data associated with said distribution and each one of a plurality of inner nodes of at least said portion of said hierarchical structure, said inner nodes being superior to said leaf nodes; and
determine entropic data for said item based, at least in part, on said distribution data and said dependency data.

20. The computer program product as recited in claim 19, wherein said hierarchical structure comprises at least one structure selected from a group of structures comprising a tree and a sub-tree.

21. The computer program product as recited in claim 19, wherein at least a portion of said dependency data comprises weighted dependency data.

22. The computer program product as recited in claim 19, wherein said computer-readable medium further-comprises instructions for causing said at least one processing unit to apply at least one weighting parameter to at least a portion of said dependency data.

23. The computer program product as recited in claim 22, wherein said computer-readable medium further comprises instructions for causing said at least one processing unit to establish said at least one weighting parameter based, at least in part, on at least one cost function.

24. The computer program product as recited in claim 19, wherein said computer-readable medium further comprises instructions for causing said at least one processing unit to determine a tree entropy value using a tree entropy function.

25. The computer program product as recited in claim 24, wherein said computer-readable medium further comprises instructions for causing said at least one processing unit to determine a tree divergence value based, at least in part, on said tree entropy function, wherein said tree divergence value is associated with said distribution and another distribution associated with another item as classified into said taxonomy.
